(19) United States
(12) Patent Application Publication
(10) Pub. No.: US 2010/0277385 A1
(43) Pub. Date: Nov. 4, 2010

(54) PHASED ARRAY ANTENNA

(76) Inventors: Gareth Michael Lewis, Essex (GB); Robert Ian Henderson, Essex (GB)

Correspondence Address: KENYON & KENYON LLP, ONE BROADWAY, NEW YORK, NY, 10004, US

(21) Appl. No.: 12/305,357

(22) PCT Filed: Oct. 3, 2008
(86) PCT No.: PCT/GB08/50901

§ 371 Date: Jun. 16, 2010

(30) Foreign Application Priority Data
Oct. 9, 2007 (EP) 07270057.8
Oct. 9, 2007 (GB) 0719680.1

(51) Int. Cl. H01Q 1/00; H01Q 9/16

(52) U.S. Cl. 343/787

(57) ABSTRACT

Phased array antennas, in particular highly coupled arrays of dipoles having a vertical electrical feed structure. A phased array antenna including a plurality of antenna elements and a plurality of electrical feed structures, wherein each feed structure serves an antenna element and each electrical feed structure is at least partially substantially surrounded by a ferrite element.

### RELATED APPLICATION INFORMATION

This application is a United States National Phase Patent Application of International Patent Application No. PCT/GB2008/050901 which was filed on Oct. 3, 2008, and claims priority to British Patent Application No. 0719680.1, filed on Oct. 9, 2007, and claims priority to European Patent Application No. 07270057.8, filed on Oct. 9, 2007, the disclosures of each of which are incorporated herein by reference.

### FIELD OF THE INVENTION

The present invention relates to phased array antennas. Phased array antenna systems are well known in the antenna art. Such antennas generally include a plurality of radiating elements that are individually controllable with regard to relative phase and amplitude. The antenna pattern of the array is selectively determined by the geometry of the individual elements and the selected phase/amplitude relationships among the elements. Typical radiating elements for such antenna systems may include dipoles, slots or any other suitable arrangement.

### BACKGROUND INFORMATION

Microwave antennas include a wide variety of designs for various applications, such as satellite reception, remote broadcasting, or military communication. For low profile applications printed circuit antennas may be used.

A schematic diagram of a low profile, highly coupled dipole array is illustrated in FIG. 1. Each dipole in this particular array has a span of around 10 mm. The target bandwidth of the antenna array is approximately 2 GHz to 18 GHz. Dipoles are more attractive for use in a low profile antenna array than Vivaldi elements, for example, which are much taller for a similar range of frequencies.

A typical dipole array forms part of a layered structure, including a substrate upon which the dipole array is printed and spacer material separating the dipole array from a ground plane. Dielectric layers may also be included to improve the performance at wide scan angles.

However, there is a problem with using such a highly coupled dipole array for applications requiring a low profile antenna. Such antennas have a vertical feed structure which extends through the ground plane to connect the elements of the dipole array to a driving circuit.

A problem arises with feeding a planar array of dipoles, for example, because the vertical feed structure will support unwanted currents. In a scanned array, these unwanted currents are present even when using a balanced feed structure such as twin wire transmission line. These currents are excited at the frequencies and range of scan angles over which the antenna will work effectively.

In order to avoid the problem of unwanted common-mode currents due to the feed structure it would be possible to feed an array of diploes using an optical fiber feeding an active device. However, this solution would be expensive and largely constrained to receive only applications due to the limited transmit power. Furthermore whilst an optical feed structure might be possible at lower frequencies which mean larger dipole structures due to larger wavelengths this will become less feasible for smaller dipole structures such as those working around 10 GHz.

It is desirable to produce a phased array antenna having high bandwidth and high scan range whilst also having a low profile and being lightweight. Of course, it is also desirable to produce such antenna at as low a cost as possible.

### SUMMARY OF THE INVENTION

According to the invention there is provided a phased array antenna including: a plurality of antenna elements; a plurality of electrical feed structures each feed structure serving an antenna element; wherein each electrical feed structure is at least partially surrounded by a ferrite element for the suppression of unwanted currents in the feed structure.

In an exemplary embodiment, the antenna elements are printed on a substrate each feed structure extends from a ground plane to the substrate to connect to the antenna element served by said feed structure; and the ferrite element includes a cylinder surrounding at least part of the feed structure.

In one embodiment the ferrite element includes a plurality of cylinders each cylinder surrounding at least part of said feed structure. In another embodiment, the ferrite element includes a first ferrite ring disposed near the substrate and a second ferrite ring disposed near the ground plane. In a further embodiment, the ferrite element includes a cylinder extending substantially from the ground plane to the substrate.

The antenna may further include a dielectric layer supported on said substrate.

An antenna element may include a dipole or a pair of orthogonal dipoles.

In an exemplary embodiment each antenna element is capacitively coupled with at least one other antenna element.

In an exemplary embodiment the feed structure is provided by coaxial cables.

### BRIEF DESCRIPTION OF THE DRAWINGS

FIG. 1 is an illustration of one example of a highly coupled dipole array for use in a phased array antenna.

FIG. 2 is a second example of a highly coupled dipole array for use in a phased array antenna.

FIG. 3 is an illustration of an antenna element showing various layers in an antenna structure.

FIGS. 4a to 4d are an illustration of a simulated performance of a highly coupled dipole array showing the voltage standing wave ratio in the E-plane and in the H-plane and illustrating thresholds of 2:1 and 2.5:1.

FIG. 5a is an illustration of balanced currents in a feed structure.

FIG. 5b is an example of an unbalanced current in a feed structure.

FIG. 6 is an illustration of a first embodiment of the present invention.

FIGS. 7a to 7d are an illustration of a simulated performance of a highly coupled dipole array using elements as illustrated in FIG. 6 showing the voltage standing wave ratio in the E-plane and in the H-plane and illustrating thresholds of 2:1 and 2.5:1.

FIG. 8 is an illustration of a second embodiment of the present invention.

FIGS. 9a to 9d are an illustration of a simulated performance of a highly coupled dipole array using elements as illustrated in FIG. 8 showing the voltage standing wave ratio in the E-plane and in the H-plane and illustrating thresholds of 2:1 and 2.5:1.

FIG. 10 is an illustration of a third embodiment of the present invention.

FIGS. 11a to 11d are an illustration of a simulated performance of a highly coupled dipole array using elements as illustrated in FIG. 10 showing the voltage standing wave ratio in the E-plane and in the H-plane and illustrating thresholds of 2:1 and 2.5:1.

### DETAILED DESCRIPTION

Exemplary embodiments of the present invention will now be described in more detail, by way of example only, with reference to the accompanying drawings.

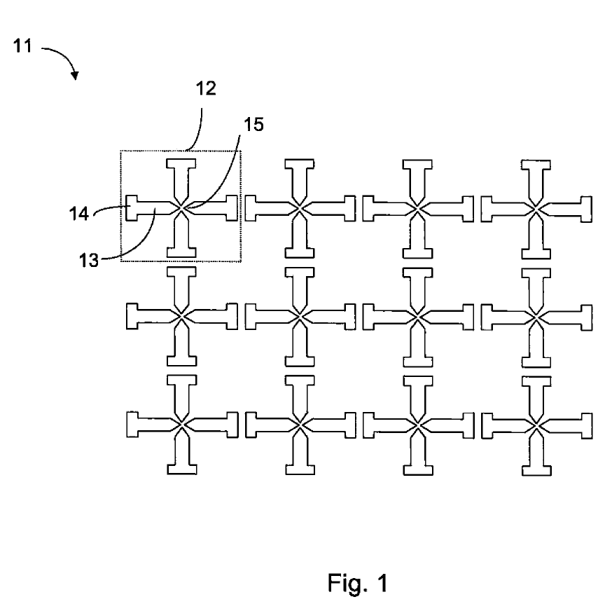

FIG. 1 illustrates schematically a highly coupled dipole array 11. Each antenna element 12 includes four conducting arms 13 which form two orthogonal dipole antennas and provide dual polarisation. T-shaped elements 14 at the end of each arm 13 increase the series capacitance between adjacent antenna elements 12 in order to improve the antenna bandwidth. Each conducting arm has a feed portion 15 located at the center of the antenna element 12 for receiving an electrical signal. A substrate for supporting the dipole array 11 (as is conventional in printed circuit antennas) is not shown.

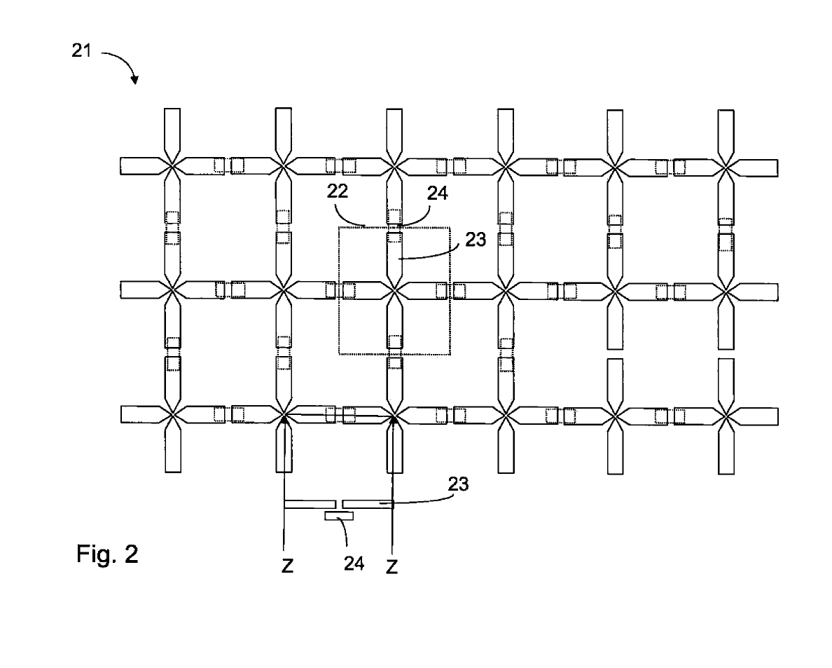

FIG. 2 illustrates schematically a second example of a highly coupled dipole array 21. Each antenna element 22 includes four conducting arms 23 which form two orthogonal dipole antennas and provide dual polarisation. Parallel line coupling elements 24 which are provided on the opposite side to that of the dipole elements on a double sided substrate serve to increase the series capacitance between adjacent antenna elements 22 in order to improve the antenna bandwidth. A section Z-Z of the antenna array is shown to illustrate a side view of a coupling element 24.

It will be appreciated that the arrangement shown in FIG. 2 is not as convenient as the arrangement shown in FIG. 1 if it is desired to produce a dipole array spanning more than one substrate section as a coupling element would have to span two substrate sections.

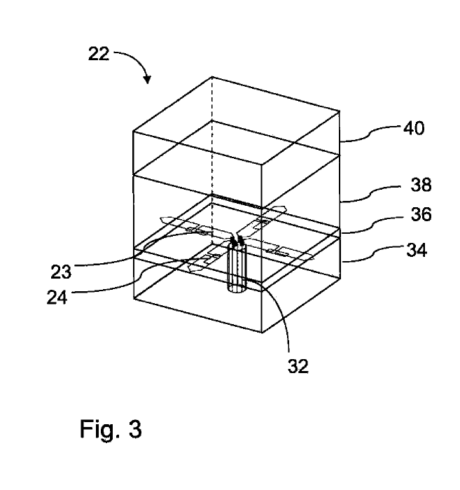

FIG. 3 is a perspective view of an antenna element 22 shown in FIG. 2 illustrating the layers which were used in an antenna simulation. The antenna element 22 is fed by a feed structure 32 including a coaxial cable feeding each conducting arm 23. A spacer layer 34 separates the antenna element 22 from a ground plane (not shown). A substrate layer 36 supports the antenna elements 23, 24. Because the substrate layer 36 has a dielectric constant of 2.2 and air has a dielectric constant of approximately 1, the dielectric layers 38, 40 serve to smooth the differences in the dielectric properties between the substrate 36 and air and improves the scan angle of the antenna array 21. In this example, a first dielectric layer 38 having a dielectric constant of 2.0 supports a second dielectric layer 40 having a dielectric constant of 1.33 between the substrate layer 36 and air. In this description the feed structure is sometimes referred to as a vertical feed structure, although it will be appreciated that the dipole array 21 may be in any orientation when in use.

One method of illustrating the performance of an antenna is to plot a representation of the voltage standing wave ratio (VSWR) in the plane of the electric field (the E plane) and the plane of the magnetic field (the H plane) which are orthogonal to one another. Such plots can be generated using conventional antenna modelling software.

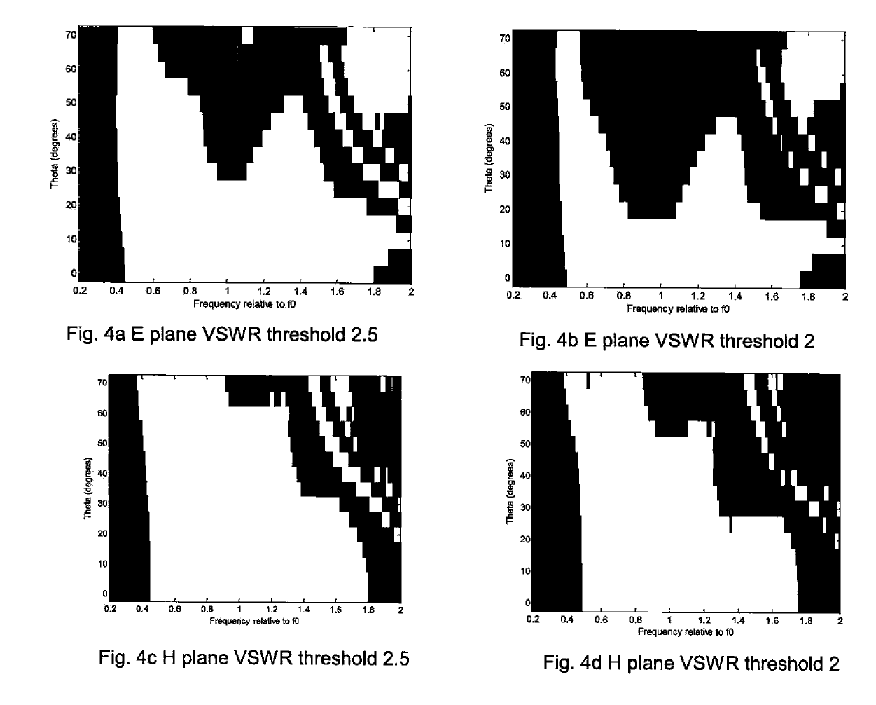

FIGS. 4a to 4d illustrate the simulated performance of a dipole array antenna with antenna elements as shown in FIG. 2 with no measures to suppress any unwanted currents. The array scan angle considered varies from 0° to 70° and the frequency range is considered between 0.2f₀ and 2f₀, where f₀ is equal to 10 GHz.

Ideally the VSWR should be below 2:1 but a ratio of 2.5:1 can be tolerated for very wide bandwidth and scan angle operation. In FIGS. 4a to 4d a VSWR of below a chosen threshold is shown in white and a VSWR of above the chosen threshold is shown in black.

FIG. 4a illustrates a simulated scan in the E plane with a VSWR threshold of 2.5. FIG. 4b illustrates a simulated scan in the E plane with a VSWR threshold of 2.0. FIG. 4c illustrates a simulated scan in the H plane with a VSWR threshold of 2.5. FIG. 4d illustrates a simulated scan in the H plane with a VSWR threshold of 2.0.

It can be seen from FIG. 2 that in the E-plane the scan range is limited at around f₀, to between approximately 15° and 30° depending upon which VSWR threshold is acceptable.

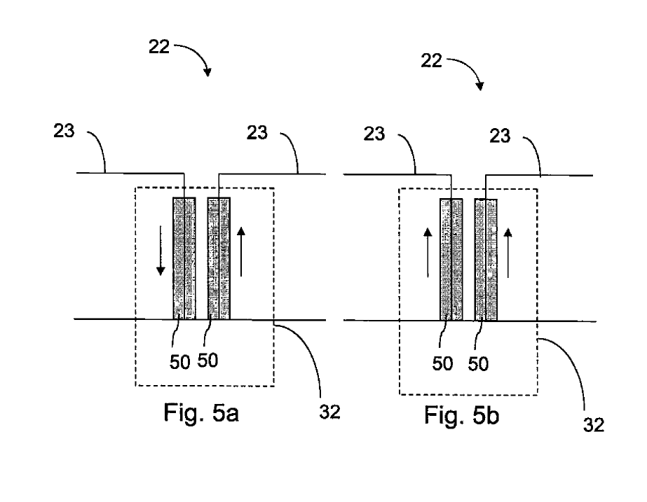

This limited scan range is due to unwanted currents in the feed structure 32. FIGS. 5a and 5b show conductive arms 23 fed by the feed structure 32, each conductive arm being fed by a coaxial cable 50. FIG. 5a illustrates balanced currents in the feed structure. FIG. 5b on the other hand shows unbalanced currents.

In this invention the vertical feed structure of the phased array antenna is screened using an appropriately shaped ferrite element. The theoretical E and H plane scan characteristics are modelled including the electrical characteristic of such a ferrite element. One skilled in the art will understand that due to the electrical properties of ferrite, a ferrite element appears electrically very large. Small mechanical differences may mean very large electrical differences. Although the antenna dimensions are less than ½ wavelength the ferrite element will appear to be several wavelengths. Therefore small mechanical differences in the ferrite element will potentially cause large electrical differences and a large difference to the performance of the antenna. Several shapes and configurations of ferrite elements have been considered and modelled to determine exemplary embodiments.

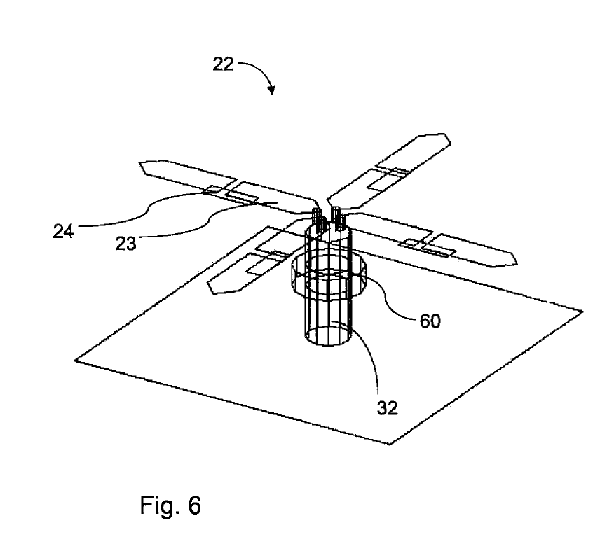

FIG. 6 illustrates a first embodiment of the present invention. The antenna element 22 is fed by a feed structure 32 including four coaxial cables. The feed structure 32 has a ferrite ring 60 surrounding a portion of the feed structure 32.

The ferrite modelled for this example is a typical ferrite including magnesium ferrites and nickel ferrites.

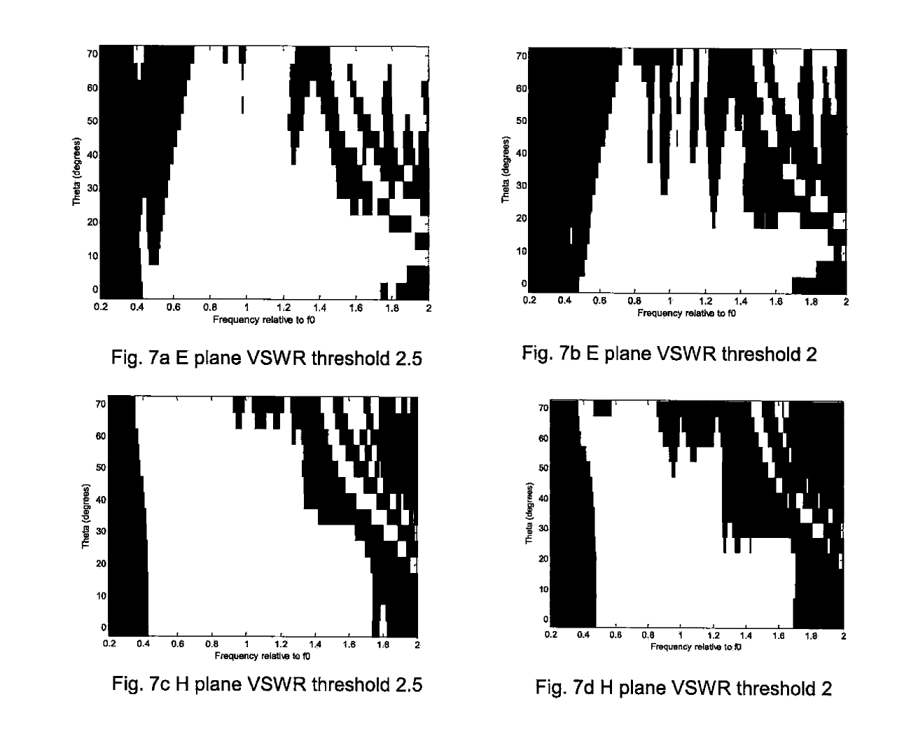

For the theoretical modelling the ferrite is assumed lossless and is assumed to have a relative dielectric constant ∈ᵣ=13 and a relative permeability of μᵣ=50. FIGS. 7a to 7d show simulated scans modelling the antenna element shown in FIG. 6.

FIG. 7a illustrates a simulated scan in the E plane with a VSWR threshold of 2.5. FIG. 7b illustrates a simulated scan in the E plane with a VSWR threshold of 2.0. FIG. 7c illustrates a simulated scan in the H plane with a VSWR threshold of 2.5. FIG. 7d illustrates a simulated scan in the H plane with a VSWR threshold of 2.0.

It can be seen from these simulations that the scan range in the E plane is improved, although when a VSWR threshold of 2 is considered there are still some frequencies where the scan angle will be limited.

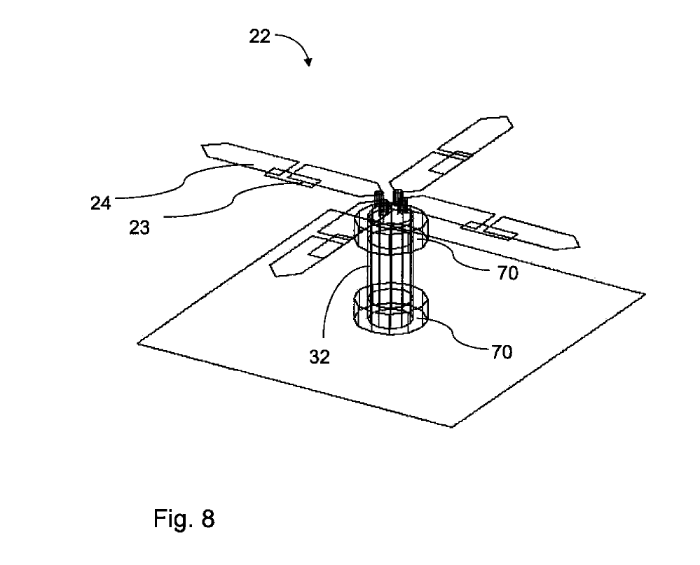

FIG. 8 illustrates a second embodiment of the present invention. The antenna element 22 is fed by a feed structure 32 including four coaxial cables. The feed structure 32 has two ferrite rings 70 surrounding an upper portion and a lower portion of the feed structure 32.

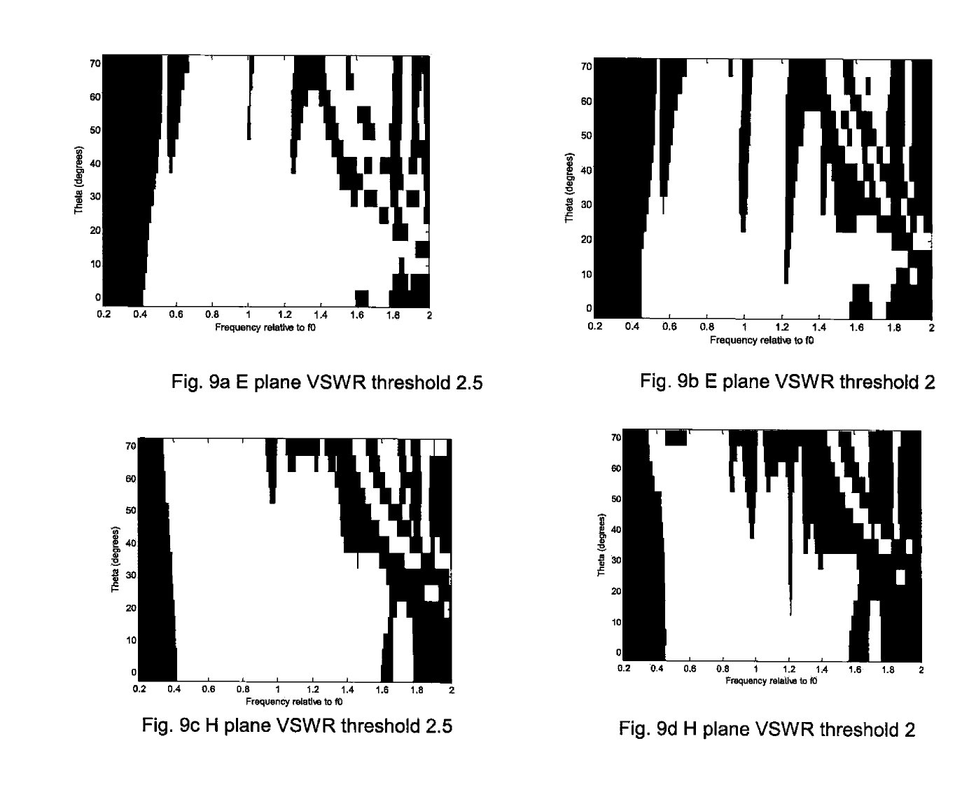

FIGS. 9a to 9d show simulated scans modelling the antenna element shown in FIG. 8.

FIG. 9a illustrates a simulated scan in the E plane with a VSWR threshold of 2.5. FIG. 9b illustrates a simulated scan in the E plane with a VSWR threshold of 2.0. FIG. 9c illustrates a simulated scan in the H plane with a VSWR threshold of 2.5. FIG. 9d illustrates a simulated scan in the H plane with a VSWR threshold of 2.0.

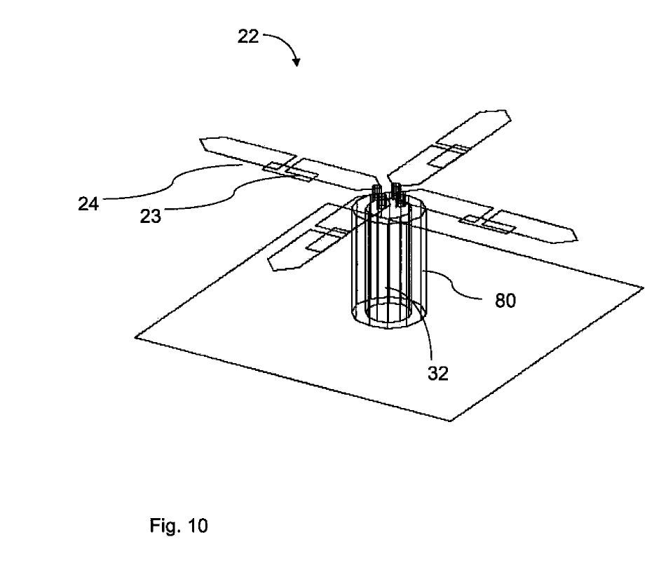

FIG. 10 illustrates a third embodiment of the present invention. The antenna element 22 is fed by a feed structure 32 including four coaxial cables. The feed structure 32 has a ferrite tube 80 surrounding substantially the full length of the feed structure 32.

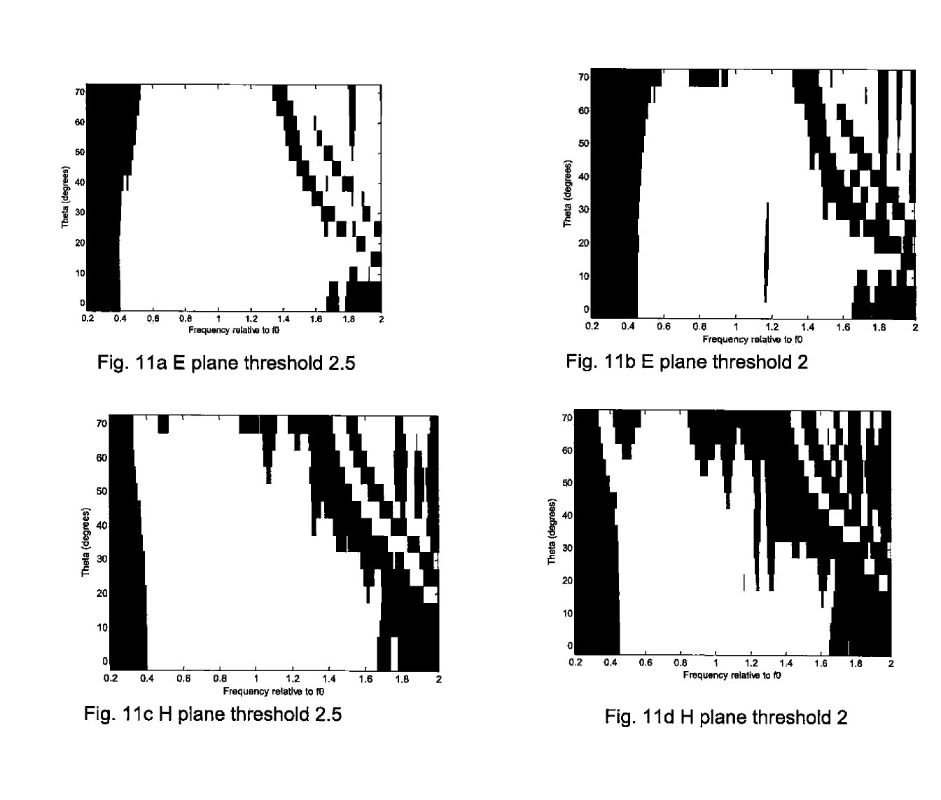

FIGS. 11a to 11d show simulated scans modelling the antenna element shown in FIG. 10.

FIG. 11a illustrates a simulated scan in the E plane with a VSWR threshold of 2.5. FIG. 11b illustrates a simulated scan in the E plane with a VSWR threshold of 2.0. FIG. 11c illustrates a simulated scan in the H plane with a VSWR threshold of 2.5. FIG. 11d illustrates a simulated scan in the H plane with a VSWR threshold of 2.0.

Comparing the illustrations in FIGS. 4-4d, 7a-7d, 9a-9d and 11a-11d it is apparent that the greatest benefit is achieved when the ferrite element surrounds as much as the feed structure as is possible, and extends from as close as the ground plane as possible to as close to the substrate as possible. However, a ferrite element surrounding only certain portions of the feed structure nevertheless provides some benefit.

It will be appreciated that various alterations, modifications, and/or additions may be introduced into the constructions and arrangements of parts described above without departing from the scope of the present invention as defined in the appended claims.

Although the invention has been discussed specifically referring to co-axial cables, any vertical feed structure, for example strip line or any other electrical conductor feeding an antenna array in parallel will benefit from the use of ferrite elements to suppress unwanted currents in the feed structure.

Although the invention has been described, and the simulations carried out using two dielectric layers between the antenna array and air, fewer, more or no dielectric layers may be used. Furthermore one or more dielectric layers may be provided between the antenna array and the ground plane.

Although arrays of antenna elements having four conducting arms are used in the above simulations, the invention will also benefit arrays of antenna elements having two conducting arms and will also benefit other types of antenna array structure where a parallel (or ‘vertical’) electrical feed structure is required

Various embodiments of the ferrite element have been simulated. However, a small gap in the structure will still provide a reduction in unwanted currents, so any ferrite element substantially surrounding at least a portion of an electrical feed structure will show some benefit.

1-11. (canceled)

12. A phased array antenna, comprising:
a plurality of antenna elements; and
a plurality of electrical feed structures;
wherein each feed structure serves an antenna element, and each electrical feed structure is at least partially surrounded by a ferrite element.

13. The phased array antenna according to claim 12, wherein:
the antenna elements are printed on a substrate,
each feed structure extends from a ground plane to the substrate to connect to the antenna element served by said feed structure, and
the ferrite element comprises a cylinder surrounding at least part of said feed structure.

14. The phased array antenna according to claim 13, wherein the ferrite element includes a plurality of cylinders, and each cylinder surrounds at least part of at least one of the plurality of feed structures.

15. The phased array antenna according to claim 14, wherein the ferrite element includes a first ring near the substrate and an second ring near the ground plane.

16. The phased array antenna according to claim 13, wherein the ferrite element includes a cylinder extending substantially from the ground plane to the substrate.

17. The phased array antenna according to claim 13, further comprising:
a dielectric layer supported on the substrate.

18. The phased array antenna according to claim 12, wherein an antenna element includes a dipole.

19. The phased array antenna according claim 18, wherein an antenna element includes a pair of orthogonal dipoles.

20. The phased array antenna according to claim 12, wherein each antenna element is capacitively coupled with at least one other antenna element.

21. The phased array antenna according to claim 12, wherein the feed structure is provided by coaxial cables.
